(19) United States
(12) Patent Application Publication
(10) Pub. No.: US 2007/0112173 A1
(43) Pub. Date: May 17, 2007

(54) Method and device for the continuous production of polymer

(76) Inventor: Rudolf Kämpf, Haingrundau (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/569,846

(22) PCT Filed: May 26, 2004
(86) PCT No.: PCT/EP04/05653

§ 371 Date: Nov. 17, 2006

(30) Foreign Application Priority Data
Aug. 7, 2003 (DE) 10336164.2

(51) Int. Cl. C08G 69/08; C08G 79/02

(52) U.S. Cl. 528/398; 528/373; 528/310

(57) ABSTRACT

In a method for the continuous manufacture of polymers by means of melt condensation of a monomer in each case with itself or with at least one other monomer the molten monomers are esterified or transesterified in the presence of a catalyst, subsequently the esterification/transesterification product is fed for the precondensation to a disc ring reactor, then the precondensation product is fed to an LVS disc ring reactor for the polycondensation and finally the polycondensation product is fed to the end polycondensation.

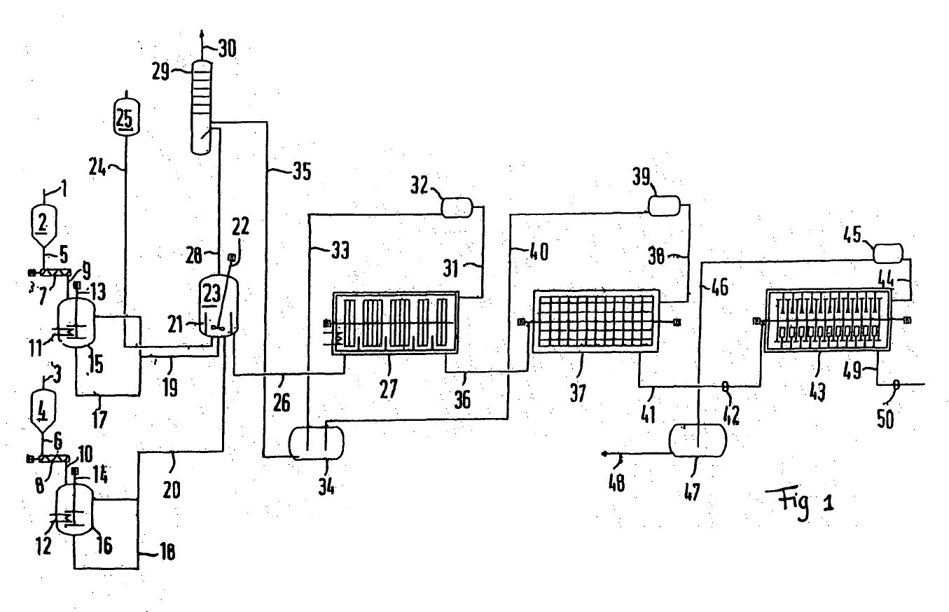

The invention relates to a method and a device for the continuous manufacture of polyphosphonates, polysulfones, polyarylates, polyamides, polyaryleneethers and polyetherketones by means of melt condensation of a hydroxycarbonyl, dicarboxylic acid, anhydride, phosphoric acid, phosphono, phosphonate, phosphino, phosphinate, carbonyl, carboxyl, sulfonyl, sulfonate, siloxane and amino group carrying monomer in each case with itself alone or with at least one of the monomers diphenol, dialcohol, diamine and carbonate.

From DE-A-10059616 a method is known for the manufacture of polycarbonates by means of conversion of a monomeric carbonate component with at least one diphenol or dialcohol in presence of a transestrerification catalyst, wherein the molten components are stirred with the transesterification catalyst and a transesterification product is produced that is polycondensed. The polycarbonates produced should possess as narrow a molecular weight distribution and as few side chain branches as possible and be as free as possible of black particles, an infinitesimally small yellow coloration and only a small gel content. That is thereby achieved in that the transesterification product is fed to the polycondensation through a pre-reactor, at least one intermediate reactor and an end-reactor. The series-connected reactors have an essentially horizontally driven shaft with attached stirring elements. The temperatures in the pre-reactor lie in the range from 220 to 300° C. and in the end reactor in a range from 240° C. to 350° C., wherein the pressure in the pre-reactor amounts to 100 to 800 mbar and in the end-reactor 0.1 to 50 mbar. The number of series connected intermediate reactors is customarily from 1 to 3. The vapors are evacuated from each reactor. The holding time of the melt in the pre-reactor and in the end-reactor amounts in each case to 5 to 120 min.

It has not been lacking in experimental tests to introduce this technical teaching to the continuous manufacture of polyphosphonates, polysulfones, polyarylates, polyamides, polyaryleneethers and polyetherketones by means of melt condensation of hydroxycarbonyl, dicarboxylic acid, anhydride, phosphoric acid, phosphono, phosphonate, phosphino, phosphinate, carbonyl, carboxyl, sulfonyl, sulfonate, siloxane and amino group carrying monomers in each case with itself alone or with at least one of the monomers diphenol, dialcohol, diamine and carbonate; have not led to the desired result.

So that the previously cited polymers have a b-index (yellow-blue-tinge) of <10, an L-index (light translucense) >80 and a polydispersity between 2 and 5 as well as a gel content of at the most 1000 mg/1000 g and only a few black particles are present it is provided for in accordance with the invention, that the molten monomers are fed into a stirred reactor and are esterified or transesterified in this at a temperature of 150 to 300° C., a pressure of 500 to 5000 mbar and a holding time of 10 to 240 min in the presence of an added catalyst, the esterified or transesterified product having a viscosity of 0.1 to 100 Pa·s for the precondensation in a disc ring reactor at a pressure of 5 to 95% of the pressure prevailing in the stirred reactor, with a holding time of 10 to 90 min is heated and precondensed continuously at a 30 to 120° C. higher temperature compared to the entry temperature, and that a pre-condensation product having a viscosity of 10 to 1000 Pa·s for the polycondensation in at least one LVS disc ring reactor at a pressure of 5 to 95% compared to the pressure prevailing in the pre-condensation stage lowered pressure, with a holding time of 10 to 90 min and a shear rate of at least 0.05/s is heated continuously to a 30 to 70° C. higher temperature compared to the entry temperature and that a polycondensation product having a viscosity of 100 to 10,000 Pa·s is subsequently fed for the end polycondensation into an HVS disc ring reactor at a lowered pressure of 5 to 95% compared to that prevailing in the preceding LVS disc ring reactor, a holding time of 10 to 90 min and a shear rate of at least 0.05/s, is heated continuously to a 5 to 70° C. higher temperature compared to the entry temperature.

Advantageous embodiments of the method in accordance with the invention are given in claims 2 through 8.

Suitably the cleavage product containing vapors precipitating from the esterification/transesterification of the precondensation, of the polycondensation and the end polycondensation, the monomers produced by means of fractionating condensation or by means of distillation and are returned to the process, wherein the mole ratio of fresh and returned monomers in the stirred reactor, depending on the vapor pressure of the monomers to each other and on the reaction conditions amounts 1:1.0001 to 1:3.5 preferably 1:1.1 to 1:2.5. The vapors are evacuated with only small underpressure, wherein vapor and liquid jet pumps have been shown as specially reliable.

In reference to good color values, small thermal stress and with polymers having structurally viscous behavior, it is advantageous to raise the temperature of the precondensation product before entry into the polycondensation and/or the polycondensation product before entry into the end-polycondensation by 2 to 50° C. by concomitant tube heating or a heat exchanger.

According to another feature of the invention in the case of a polymer breakdown as a result of too large a thermal stress through shear stress it can be appropriate by means of reactor elements, to lower the temperature of the precondensation product before the entry into the polycondensation and/or of the polycondensation product before entry into the end-polycondensation, for example through concomitant tube cooling or a heat exchanger, by 2 to 30° C.

The continuous manufacture of polymers through precondensation, subsequent polycondensation and end polycondensation by means of three disc ring reactors arranged in series one after the other, the one plug flow with almost equal local holding time of the monomers and a wide holding time allowed, it is possible to raise the temperature in the disc ring reactor stepwise and adjust the necessary underpressure for vapor deposition of the cleavage product. This adjustment has the advantage that in the pre-condensation for relatively lower viscosity and compared with the end-polycondensation relatively low melting point of the polymer can be set at lower temperatures.

In order to achieve an optimal plug flow in the disc ring reactors, the ratio of length to internal diameter amounts to 0.5:1 to 10:1, preferably 2:1 to 5:1.

For the adjustment to increasing amount of cleavage products with the decreasing pressure, for the prevention of higher flow rates and the resulting carryover of small liquid droplets one or more disc ring reactors can be shaped conically, wherein the ratio of length to diameter of the inner space can amount to <1.1:1, preferably 0.5:1 to 1:1 at the narrowest points.

The disc ring reactor for carrying out the pre-condensation comprises a horizontal cylindrical container having a double external mantle for heating and adjustment of the necessary temperature in the reaction space, in whose lower section of the front side where the esterification/transesterification product enters horizontally. The discharge of the pre-condensation product takes place radially at the rear side towards the base and opposite to the radial discharge of the vapors outlet towards the top or axially behind or below. In the reaction space are at one passing-through shaft at the disc rings fastened to the spokes arranged individually or in a network according to each melt viscosity being processed. The disc rings rotate in the lower section of the container located through single sheet separated chambers, which prevent the esterification/transesterification product entering into the reaction space from flowing unmixed through the outlet. The sheet walls are provided with specially configured openings which guarantee a targeted product exchange from chamber to chamber. The disc rings take the esterification/transesterification product from the approximately 75% filled chambers and transport this onto the disc ring. After exceeding the horizontal the effect of gravity becomes increasingly stronger in occurrence and makes it possible for the adhering layer to be held back in two ways in the chambers and to become mixed again therein. The path along the disc ring leads to an accumulation, since the running down against the raised up product must run up. Through this obstruction a vertical running off and dripping off from the inner edges of the disc rings is strongly assisted, and thin haze and films with large surface area come into being over the total free disc area, which flow back into the sump and are there mixed in.

The higher melt viscosities of the precondensation product compared to the esterification/transesterification product necessitates an intensive mixing in order to prevent the emergence of breakdown in the polycondensation. Therefore shearing elements must be built into the container, in order to clean off the reactor walls and the stirring discs and to freshly mix or distribute the product. That happens in the so-called LVS disc ring reactor (L=Low, V=Viscosity, S=Self-cleaning), which comprises a horizontal cylindrical container with heatable double mantle and a planar front and rear sides. The precondensation product is fed from the front side horizontally into the lower section of the reactor and/or the shaft storage in the cover. The fume outlet is located at the end of the reactor space on the reactor periphery or on the rear side. In the front section, preferably in the front third of the reactor there is a shaft stump with a plurality of disc rings with spokes fastened thereto and at the ends a short shaft stub arranged with a disc ring fastened to it. These disc rings are connected by means of an extended transverse element over the length of the reactor vessel, to which in the section between the two shaft stubs other disc rings are attached, so that the agitator constitutes a sort of self-supporting cage. The transverse elements have a beveled adjustment and fulfill cropping functions. Optionally the polymer product outlet is equipped with a special stator or a wall scraper. Scraper and disc rings are applied as tightly as possible along the container wall.

For the production of the end polycondensation product, compared to the esterification/transesterification product a polycondensation product possessing a comparatively higher melt viscosity is fed to a so-called HVS disc ring reactor (H=High, V=Viscosity, S=Self-cleaning), which comprises a cylindrical container with heatable double mantle and flat covers on the front and rear side. The fume outlet is located according to requirements on the container periphery or in the rear product outlet sides of the container. The HVS disc ring reactor has a heatable hollow shaft in the reaction space, which holds the rotatable disc rings (stirring elements). Between the disc rings tightly fitting wipers are arranged, that as well as the shaft also extend a short distance past the disc rings, wherein a part of the wipers serves through a correspondingly formed profiling at the same time as congestion elements. The end polycondensation product is carried through a radially oriented pipe-end exit.

Such disc ring reactors are described in the periodical: Kunstoffe 82 (1992) 1, pages 17-20.

The invention is explained by means of the simplified flow sheet in the figure.

A powdered monomeric phosphate component is fed via line 1 to the model container 2 and powdered diphenol is fed via line 3 to the model container 4, from these are given via lines 5 or 6 to dosing screws 7 or 8. The outputs from dosing screws 7,8 are fed continuously via lines 9,10 into melters provided with heat exchangers 11,12 and agitators 13,14. From the two companion heated melt pump lines 17,18 the aliquot mass flows of the molten monomers established based on the stoichiometry of the esterification/transesterification reaction are fed via lines 19,20 into the heatable boiler reactor 23 fitted with a chamber 23 and an agitator 22 to which a mixed catalyst is fed via line 24 from the receiver container 25. The esterification/transesterification product produced through reaction of the two monomers is fed via line 26 into the heatable disc ring reactor 27 for the purpose of the preconndensation. The vapors formed in the esterification/transesterification flow via line 28 to distillation column 29 in which the cleavage products carried over the top are discharged via line 30. The vapors are exhausted from the disc ring reactor 27 via line 31 by means of a not further described steam or liquid jet system, which condense in container 32 transported via line 33 to the collection container 34 and fed via line 35 to the distillation column 29. The precondensation product leaving the disc ring reactor flows via line 36 via the storage of the agitator into the LVS disc ring reactor 37, from which the vapors are exhausted via line 38. by means of a not further described steam or liquid jet system, are condensed in container 39, fed via line 40 to the collection container and from there transported via line 35 to distillation column 29. The polycondensation product coming from the LVS disc ring reactor 37 via line 41 is fed by means of at least one gear pump 42 to the HVS disc ring reactor 43. By means of a not further explained steam or liquid jet system the vapors are evacuated via line 44, condensed in container 45, fed via line 46 to the collection container 47 and fed from this via line 48 to the distillation column 29. The end polycondensation product is carried away via line 49 using a gear pump 50 and fed for further processing.

In the following the method in accordance with the invention is explained by means of several embodiment examples. The precondensation is carried out in a disc ring reactor with a reaction space volume of 50 l and a ratio of length:diameter of 6. The polycondensation is carried out in an LVS disc ring reactor with a reaction space volume of 48 l and a ratio of length:diameter of 4. For the end polycondensation an HVS disc ring reactor with a reaction space volume of 45 l and a length:diameter ratio of 2.5 is employed. The throughput in relation to the amount of end polycondensation product amounts to 50 kg/h. The average residence time of the products in the individual disc ring reactors is determined by tracer marking.

### 1. EMBODIMENT EXAMPLE

Powdered bisphenol A is brought continuously from the receiver container 2 and powdered diphenylmethyl phosphate is brought continuously from receiver container 4 into the melter 15 or 16 and the aliquot mass flows of the molten monomers established based on the stoichiometry of the reaction are fed into the stirred boiler reactor 23. Addition of a mixed catalyst into the stirred boiler reactor 23 is carried out from the receiver 25, comprising an alkali salt of bisphenol and zinc acetate. The reaction of the two monomers takes place at a temperature of 240° C. and a pressure of 800 mbar. The phenols liberated thereby are sampled and weighed in order to determine reaction progress. The transesterification product coming from the stirred boiler reactor 23 still possesses a low melt viscosity and still contains small amounts of unreacted monomers. The molecular weight distribution of the remaining content of monomers and the average molecular weight are monitored by means of chromatography. The transesterification product is fed to the disc ring reactor 27 operated at a pressure of 200 mbar, in which over the length of the reaction space a continuous heating from 240° C. to 280° C. is carried out. The transesterification product is thereby condensed in thin films of large surface area by means of the rotating disc rings that are provided with holes, with a residence time of 30 min, to chain lengths of 10 repeating units. The cleavage products formed are evacuated, condensed and fed to distillation column 29 for re-processing. From disc ring reactor 27 the precondensation product flows at a pressure of 15 mbar into the operating LVS disc ring reactor 37, over whose reaction space length the precondensation product is heated in less than 20 min to a temperature of 305° C. Through that with a chain length of 20 to 55 repeating units condensable polycondensation product it is necessary for the precondensation product to undergo shear forming through appropriately attached shear elements and thereby to obtain an intensive mixing. From the LVS disc ring reactor 37 the polycondensation product goes into the HVS disc ring reactor 43, in which this is heated continuously over the length of the reaction space to a temperature of 330° C. at a pressure of 1.5 mbar and a residence time of 20 min, and thereby the polycondensation is completed. Since the melt viscosity of the polycondensation product increases continuously over the length of the reaction space underlies an increased shear forming the polymerization product. The end-polycondensation product coming from the HVS disc ring reactor 43 has only a small yellow coloration through breakdown products, extremely small proportions of gels and black particles as well as a narrow molecular weight distribution.

### 2. EMBODIMENT EXAMPLE

Terephthalic acid, isophthalic acid and bisphenol are added to the stirred boiler reactor 23 in the molar ratio of 1:0.75:1.75. The reaction of the monomers is initiated at a temperature of 280° C. and a pressure of 800 mbar. The water liberated thereby is collected and weighed for determination of the reaction progress. The esterification product obtained from the boiler reactor 23 is fed to the disc ring reactor 27 and in this the temperature was raised continuously from a temperature of 280° C. to a temperature of 300° C. at a pressure of 250 mbar and a residence time of 45 min over the length of the reactor space and precondensed. The cleavage products formed are evacuated and fed to the distillation column 29, The precondensation product flows into the LVS disc ring reactor 37 in this at a pressure of 25 mbar and a holding time of 20 min and is heated over the length of the reaction space continuously to a temperature of 320° C. The polycondensation product leaving LVS disc ring reactor 37 goes then into the LVS disc ring reactor 43, in which this at a pressure of 0.5 mbar and a residence time of 25 min is continuously heated over the length of the reaction space to a temperature of 330° C. and the polycondensation is brought to an end. The end-polycondensation product obtained from the HVS disc ring reactor shows only a small yellow coloration as a result of breakdown products, exceptionally small proportions of gels and black particles as well as a narrow molecular weight distribution.

### 3. EMBODIMENT EXAMPLE

From four receivers the stirred boiler reactor 23 is fed with terephthalic acid, isophthalic acid, p-phenylenediamine and o-phenylenediamine in molar ratio 1:1:1.03. From another receiver the addition of a catalyst in the form of an organo-titanium compound is carried out. The reaction of the monomers takes place at a temperature of 180° C. and a pressure of 1000 mbar. The water liberated thereby is collected and weighed for determination of the reaction progress. The esterification product obtained from the stirred boiler reactor 23 is fed to the disc ring reactor 27 in which the precondensation is carried out at a pressure of 500 mbar and a residence time of 25 min the temperature over the length of the reactor space was raised continuously from a temperature of 180° C. to a temperature of 250° C. The cleavage products formed thereby are evacuated and fed to the distillation column 29. The precondensation product flows out of the disc ring reactor 27 into the LVS disc ring reactor 37 in which a pressure of 25 mbar prevails. With a holding time of 20 min the precondensation product is heated over the length of the reaction space continuously to a temperature of 270° C. and thereby polycondensed. The polycondensation product leaving the LVS disc ring reactor 37 goes then into the HVS disc ring reactor 43, in which this at a pressure of 0.5 mbar and a residence time of 15 min is continuously heated over the length of the reaction space to a temperature of 300° C. and the polycondensation is brought to an end. The end-polycondensation product obtained possesses the same advantageous properties which the end-polycondensation products of the previous embodiment example also show.

1. A method for the continuous manufacture of polyphosphonates, by means of melt condensation of a phosphoric acid, phosphono, phosphonate, phosphino, phosphinate groups carrying monomer in each case with itself alone or with at least one of the monomers diphenol, and dialcohol, wherein the molten monomers are fed to a stirred reactor (23) and in this are esterified or transesterified at temperatures of 150 to 300° C., a pressure of 500 to 5000 mbar and a residence time of 10 to 240 min in the presence of an added catalyst, which produces an esterified or transesterified product having a viscosity of 0.1 to 100 Pa·s for the precondensation in a disc ring reactor (27) at a pressure of 5 to 95% of the pressure prevailing in the stirred reactor, for a residence time of 10 to 90 min, is heated continuously to a temperature 30 to 120° C. higher than the entry temperature, the precondensation product having a viscosity of 10 to 1000 Pa·s is fed for the polycondensation into at least one LVS disc ring reactor (37) at a 5 to 95% lower pressure compared to the pressure prevailing in the precondensation stage, with a residence time of 10 to 90 min and at a shear rate of at least 0.05/s is continuously heated to a 30 to 70° C. higher temperature compared to the entry temperature and the polycondensation product having a viscosity of 100 to 10000 Pa·s is subsequently fed for the endpolycondensation into an HVS disc ring reactor (43) at a pressure of 5 to 95% lower pressure compared with the pressure prevailing in the previous disc ring reactor (37), a residence time of 10 to 90 min and a shear rate of at least 0.05/sec is heated continuously to a 5 to 70° C. higher temperature compared to the entry temperature, characterized in that, the vapors of the depositing cleavage products of the esterification or transesterification, the precondensation, the polycondensation and the end polycondensation the monomers are recovered by means of fractionating condensation or distillation (29) and returned into the process.

2. The method according to claim 1, characterized in that the mole ratio of fresh and recovered monomers in the stirred reactor (23), depending on the vapor pressure of the monomers to each other and on the reaction conditions amounts to 1:1,001 to 1:3.5, preferably 1:1.1 to 1:2.5. 3.

3. The method according to claim 1, characterized in that the temperature of the precondensation product before the entry into the polycondensation stage (37) and/or the polycondensation product before the entry into the end polycondensation stage (43) is raised by 2 to 50° C.

4. The method according to claim 1, characterized in that the temperature of the precondensation product before the entry into the polycondensation stage (37) and/or the polycondensation product before the entry into the end polycondensation stage (43) is lowered by 2 to 30° C.

5. The method according to claim 1, characterized in that at least one solid monomer is mixed with at least one molten or liquid monomer to a paste or suspension and the mixture is fed to the stirred reactor (23).

6. A device for carrying out the method according to claim 1, characterized in that between the precondensation stage (27) and polycondensation stage (37) and/or between the polycondensation stage (37) and endpolycondensation stage (43) a heat exchanger is arranged.

7. The device according to claim 6, characterized in that the pipe lines (26,36,41) running between the stirred reactor (23) and the prepolycondensation stage (27) as well as between the precondensation stage (27) and/or the polycondensation stage (37) and/or end polycondensation stage (43) are equipped with a heating mantle.

8. The device according to claim 6, characterized in that the products fed to the disc ring reactors (27, 37, 43) in each case are feedable via the shaft storage.

9. The device according to claim 6, characterized in that in between the disc ring reactors (27, 37, 43) attached product lines (36,41) in each case at least one gear pump (42) is incorporated with coupled gears in solid separation distance.
